(19) United States
(12) Patent Application Publication
(10) Pub. No.: US 2023/0063637 A1
(43) Pub. Date: Mar. 2, 2023

(54) Car Hauler with Battery Powered Electric Actuators

(71) Applicants: Robert D. Boydstun, IV, Damascus, OR (US); Philip Ellway, Portland, OR (US); Vasiliy Sumtsov, Vancouver, WA (US); Jason Woody, Vancouver, WA (US)

(72) Inventors: Robert D. Boydstun, IV, Damascus, OR (US); Philip Ellway, Portland, OR (US); Vasiliy Sumtsov, Vancouver, WA (US); Jason Woody, Vancouver, WA (US)

(21) Appl. No.: 17/460,093

(22) Filed: Aug. 27, 2021

(51) Int. Cl. B60P 3/08; B60P 3/07; B60P 1/02

(52) U.S. Cl. CPC B60P 3/08; B60P 1/02; B60P 3/07; B60R 16/033

(57) ABSTRACT

A car hauler with battery powered electric actuators as the sole mechanism for positioning the vehicle decks. The electric actuator system completely replaces and eliminates the need for the traditional car hauler hydraulic system requiring pumps, valves, hydraulic hoses, hydraulic cylinders, hydraulic fluid reservoir, and hydraulic fluid to position the vehicle decks. The electric actuators are self-locking and do not need to be pinned like traditional hydraulic actuators. The overall weight of the electric actuator system is much less than the hydraulic actuator system and permits complete loading and unloading of the car hauler without running the diesel tractor engine.

### PRIORITY CLAIM

This application claims priority to application number 63/071,309 filed Aug. 27, 2020.

### BACKGROUND

A car hauler capable of carrying multiple vehicles over the road commonly has a series of decks on two levels that support the vehicles. The car hauler decks are movable to permit cars to be loaded and unloaded, and to be positioned for travel over the road. The disclosed car hauler uses electric motors to drive a rotary lifting device (“electric actuator”) that extends or contracts depending on the direction of rotation of a device to move the car hauler decks. The electric motors are powered by batteries. The batteries are recharged using solar panels mounted on the car hauler or by power from running the truck engine or from plugging into a shore power source. The advantages of electric actuators over traditional hydraulic actuators are many-fold.

The hydraulic system consisting of pumps, valves, motors, hydraulic hoses, hydraulic cylinders, hydraulic fluid reservoir, and hydraulic fluid that is required on all of today’s multilevel car haulers is completely eliminated in the disclosed car hauler.

The elimination of the hydraulic system reduces a significant amount of weight from the car hauler. Replacing the hydraulic actuators with a battery powered electric actuators reduces the overall weight of the car hauler on the order of 2,000 pounds. Weight is a critical characteristic of a car hauler. The maximum weight of a vehicle allowed on the nation’s roads is 80,000 pounds. A car hauler that weighs 46,000 pounds can only carry 34,000 pounds of cargo to stay under the 80,000 pound limit, whereas a car hauler that weighs 42,000 pounds can carry 38,000 pounds of cargo-which can make the difference in being able to carry the number of vehicles that can be legally loaded. Proper balancing of the allowed weight between the axles is also critical. While the overall weight of a loaded car hauler may be under the maximum limit, the load must also satisfy weight limits for each axle. Elimination of the hydraulic system also provides more flexibility in distributing weight among the axles so that the load capacity can be maximized.

For the disclosed enclosed car hauler, the energy needed to run the electric actuators can come completely from solar power in the case of an enclosed car hauler. Solar panels are mounted on the top of the enclosure for the headrack and/or the trailer. The solar panels charge batteries that store the energy needed to run the electric actuators. While the system for an enclosed car hauler with solar panels is designed with backup power sources to the solar panels, the normal mode of operation relies solely on solar power. For the disclosed open car hauler, some of the energy needed to recharge the battery may come from solar panels which may be located on the hood of the tractor.

Car haulers with traditional hydraulic actuators require the diesel truck engine to be running to power the hydraulic pump needed to move the hydraulic actuators. In contrast, all the power needed to operate electric actuators comes from a battery, the diesel truck engine of the disclosed car hauler does not need to run to provide power for running the hydraulic actuator system. Car haulers often load and unload at night to avoid traffic. Dealerships are often located close to neighborhoods. The late-night noise from diesel engines can cause problems between the dealerships and the neighborhoods. In addition, idling for certain periods of time has been outlawed in states such as California. Other states may also limit the ability of truck drivers to run their engines in idle currently or in the future. The disclosed car hauler eliminates the need to run the engine during the load/unload process thereby eliminating the noise and pollution because the electric motors are powered by batteries. The elimination of the hydraulic system also eliminates the potential for fluid leaks from the hydraulic system and the maintenance associated with hydraulic systems.

Almost all hydraulic lift systems utilize hydraulic cylinders which must be secured with manually inserted pins that prevent a deck from dropping in the case of a hydraulic system failure. Pinning the load at each new position for each deck during the loading and unloading process is extremely time consuming and tedious. Due to the time consuming and tedious nature of the pinning process, some operators will take shortcuts. Yet, the failure to properly install pins in violation of operating procedures risks severe damage to the cargo or injury to the operator himself. During the process of pinning, the operator makes numerous trips around both sides of the car hauler exposing the operator to the risks posed by passing traffic. In contrast, rotary lifting devices driven by electric motors do not require any backup device to prevent a deck from dropping in the event of failure. The pitch of the thread on the rotary device and other friction in the device prevents the deck from moving except when driven by the electric motors. The rotary device will not unwind under the weight they support or from vibration of traveling down the road. The deck can be moved to exactly the desired location using electric actuators and it will stay fixed at that location during unloading, loading or transit.

The electric actuators are actuated manually from switches located on the passenger side of the car hauler or on a remote control to keep the operator away from traffic passing the car hauler. The location of the controls allow an operator to position the decks as needed without having to move around the car hauler or expose himself to the risk of traffic all around the car hauler.

The electric actuators can also be operated automatically from the car hauler onboard computer. Encoders or sensors located on each electric motor communicate rotation information to the onboard computer which calculates the exact position of each electric actuator. Through the onboard computer, the deck positions can be set to predetermined points for loading and unloading vehicles. Each electric actuator may also have sensors at the end of travel to back up the position information determined from the encoders.

The disclosed car hauler may be capable of automatically loading vehicles without the need for drivers. A set of vehicles is selected to be transported on a car hauler and that information is input to the car hauler onboard computer. Each vehicle to be loaded has characteristics such as dimensions and weight that are captured in a database in a computer located on the car hauler. At a loading point, the car hauler computer determines the most efficient load configuration, the sequence of cars to be loaded, and the orientation of the cars to be loaded. Working through communication channels (the CAN bus, for example) the vehicle will be instructed from the car hauler’s onboard computer on whether it should be driven on, backed on, and where it should stop, to place the vehicle in the correct location for transport. Additional sensors located throughout the car hauler will create a “mini” GPS coordinate system that will help guide the car while it travels through the car hauler.

Each vehicle to be automatically loaded will have self-driving technology with a transport mode programmed into the vehicle’s onboard computer such as an Engine Control Module (ECM). The car hauler has a transponder that communicates wirelessly with each car to be loaded. The car hauler positions the deck locations for the first car to be loaded. The car hauler instructs one vehicle at a time to go into transport mode and to drive on the car hauler. The vehicle has onboard sensors for driverless control. The car hauler sensors interact with the vehicle’s sensors to keep the vehicle centered on the decks while driving through the car hauler. The “mini” GPS coordinate system can be used by a vehicle’s onboard sensors to properly locate itself in the correct location on the car hauler. Once a vehicle comes to a stop at its proper location on the car hauler, it will be secured by the operator. Between vehicles, the car hauler computer determines the correct deck positions for the next vehicle and, if a change in the deck positions is needed, commands the repositioning of the decks. The process then repeats for loading each of the vehicles.

After all the vehicles are loaded and secured, the decks are commanded by the car hauler computer to reposition into their transport positions. The transport position is determined by the car hauler computer by taking into consideration all the requirements such as sufficient spacing between the payload vehicles, and legal requirements for highways such as overhang limits, height limits, and weight limits on each axle.

Once the truck reaches its destination, the process will reverse, with the vehicles driving themselves off the car hauler one at a time when directed to do so by the car hauler computer. In the case where vehicles are to be dispatched at multiple locations, repositioning of the load may be needed to balance weight on the car hauler. The car hauler’s onboard computer will determine whether relocation is needed, the new positions, and the sequence of steps needed to relocate the vehicle positions. To relocate vehicles, the car hauler’s onboard computer will command the movements of the vehicles, moving them off the car hauler and back on to a different location as to their new positions. Any of these processes for automatic loading can be overridden or altered by the operator.

Automatic vehicle loading and unloading has many advantages over the current method of loading car haul haulers that requires a person drive each vehicle on and off a car hauler. Auto transporters (trucking companies that own and operate car haulers) have relied on highly skilled employees with a commercial driver’s license (CDL), who also possess the skills to operate the car hauler’s functions, including: hydraulic functions, manual loading and unloading, pinning, and transportation. This adds dozens independent operations that a driver needs to master that are not required for other commercial trucking occupations. Maximizing the load factor for car haulers requires a lot of experience on how to efficiently load cars to position them in a way that will maximize the number of cars and keep within the weight limits on each of the axles. The acquisition of the training and experience necessary to reliably operate a car hauler is time consuming. Training and retaining a skilled pool of drivers is difficult because drivers often opt to work in traditional truck driving, jobs that do not require the same expertise, skill, and physical agility required to operate a car hauler. Automating the loading and unloading process would increase the number of candidates who could operate a car hauler.

An operator driving a vehicle onto a car hauler has to maneuver the vehicle to properly locate the vehicle front to back to maximize the load, but also to orientate the vehicle left to right so that the driver has room to open the door and get out of the loaded vehicle. This manual maneuvering leads to mistakes that damage vehicles and become expensive losses for the business. Minor damage to one vehicle in a load may be enough to turn a profitable trip into a financial loss.

Automation of the loading and unloading process for car haulers will ultimately lead to more efficient vehicle transportation by relying less on human control and more on automation that takes advantage of ever evolving truck and vehicle technology.

Utilization of electric actuators that rely on a freely available source of energy-the sun—is more cost effective and efficient. Noise, hydraulic fluid leaks, and exhaust fumes are all reduced by switching from hydraulic actuators powered by the diesel engine to electric actuators powered by batteries that are recharged with solar energy.

Automating the system and eliminating the need for an operator to drive a vehicle onto the car hauler opens up design options for car haulers. Car haulers are designed around many constraints, and one of them is to design the support structure in a way that allows room for car doors to be opened in each of the typical positions on the car hauler. Without the need to accommodate the opening of doors, car hauler designers have more options for lighter and stronger car hauler designs.

The enclosed figures provide additional detail for the disclosed car hauler.

### BRIEF DESCRIPTION OF DRAWINGS

FIG. 1 shows a side view of an open car hauler.

FIG. 2 shows a view of an enclosed car hauler.

FIG. 3 shows a view of a sealed actuator.

FIG. 4 shows an exploded view of a sealed actuator.

FIG. 5A shows a side view of a vertical electric lift.

FIG. 5B shows a section of a vertical electric lift and a screw slide assembly.

FIG. 5C shows a screw slide assembly.

FIG. 6 shows a one-line diagram for control of AC electric motors.

FIG. 7 shows an alternative one-line diagram for control of AC electric motors.

FIG. 8 shows a one-line diagram for control of DC electric motors.

### DETAILED DESCRIPTION

### Enclosed/Open

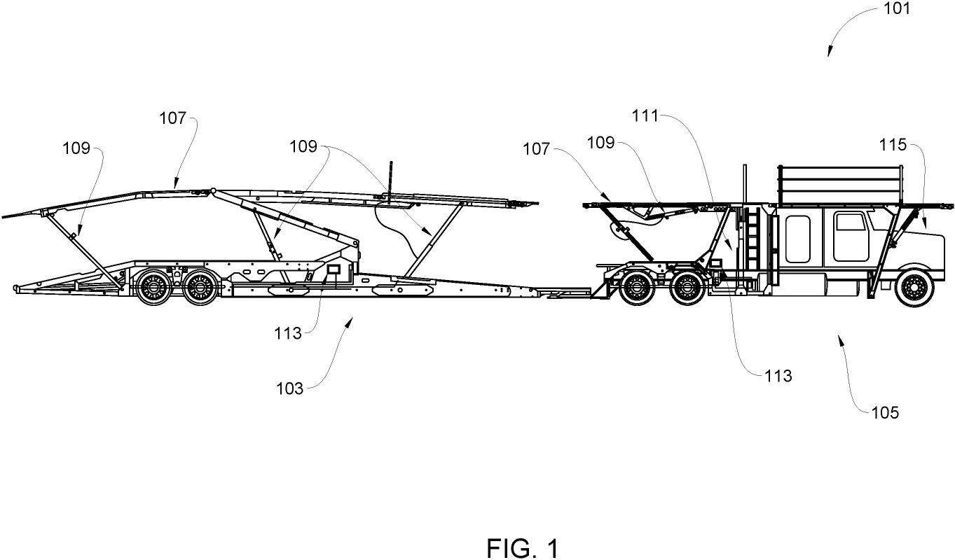

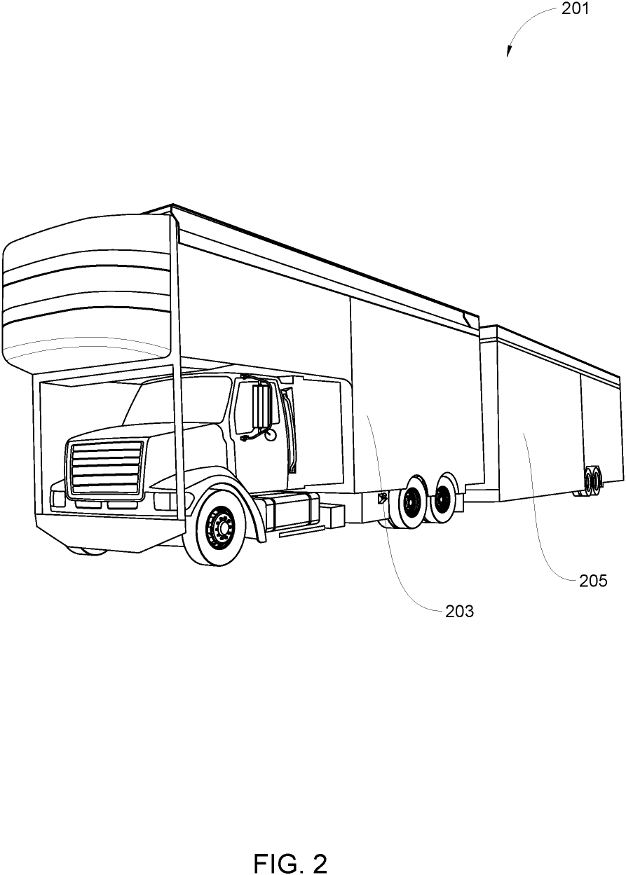

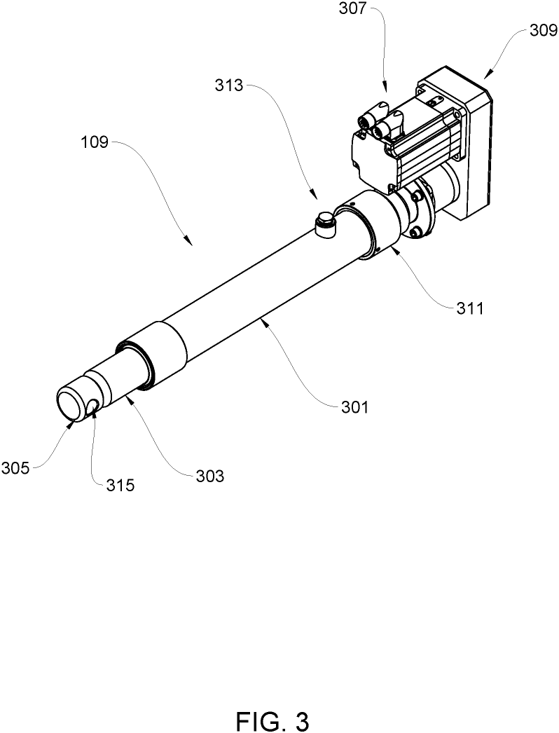

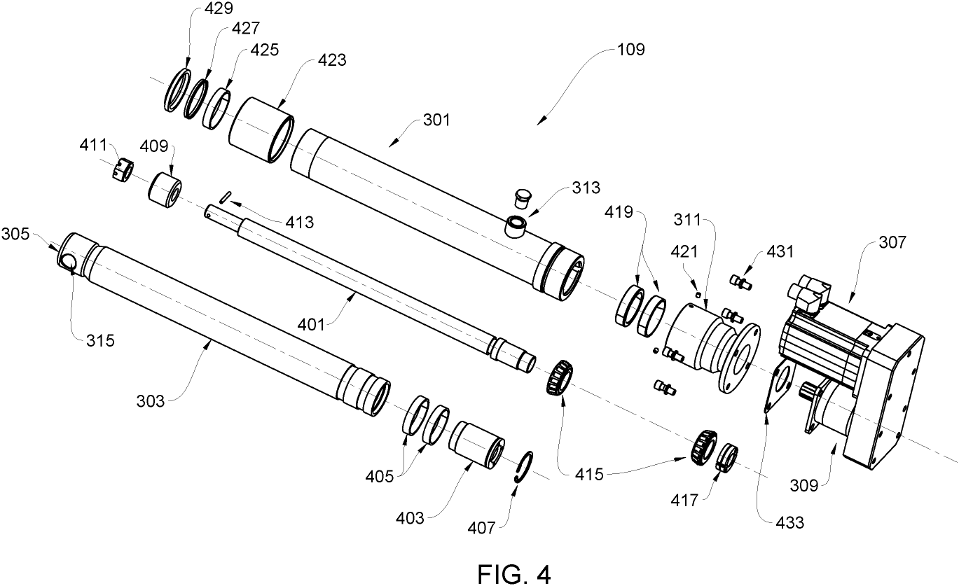

Most car haulers are open design where the payload cars and trucks are not protected from the elements as shown in FIG. 1. Open car haulers can typically carry more cars and trucks and are more flexible in handling larger vehicles. Closed car haulers as shown in FIG. 2 are used by some transporters because they provide a superior degree of protection from the elements to the payload cars and trucks.

### Actuators and Vertical Screws

Electric actuators are deployed in two configurations on an open car hauler 101, a sealed electric actuator 109 and a vertical electric lift 111, together referred to as electric actuators.

Sealed electric actuators 109 are deployed in locations where the actuator needs to be angled and to change angles relative to a vertical plane as the sealed electric actuator 109 is extended and retracted. Sealed electric actuators 109 have the advantage that the screw is sealed inside two telescoping cylindrical tubes which protects the screw from grit from the road. The lubrication for the screw in a sealed electric actuator 109 is also captured in the two telescoping cylindrical tubes and is prevented from leaking out. A significant design advantage of sealed electric actuators 109 is that they can be advantageously placed in different locations on the car hauler 101 to create the desired movement of the decks 107 and in locations that minimize obstacles to car doors being opened when cars are loaded and unloaded from the car hauler 101. A disadvantage of a tube actuator 109 is that its stroke, the degree to which it can change length is limited and is much less that the length of the internal screw. For example, the stroke of a sealed electric actuator 109 with a 60-inch screw may only be 24 inches.

A vertical electric lift 111 is advantageous because the stroke of the actuator is nearly the same length of the screw. The screw in a vertical electric lift 111 is not sealed from the outside environment. The vertical electric lift 111 also has a fixed physical length. Having vertical electric lifts with a fixed physical length creates obstacles to opening car doors-particularly for larger vehicles like pickup trucks-when unloading and loading an open car hauler 101. In preferred designs for an open car hauler 101, the vertical electric lift 111 is most useful at a forward location adjacent to the rear of the cab on the headrack 105. In an enclosed car hauler 201, most of the electric actuators are vertical electric lifts 111 because in an enclosed car hauler, the vertical electric lifts 111 do not present significant additional obstacles to the obstacles inherent in the headrack enclosure 203 or the trailer enclosure 205.

Two sizes of sealed electric actuators 109 are used, 5,000 lbs and 10,000 lbs. A sealed electric actuator 109 has a lower tube 301, and upper tube 303, end cap 305, electric motor 307, planetary gear box 309, bearing housing 311, and plug 313. The upper tube 303 telescopes inside the lower tube 301. The end cap 305 at the end of the upper tube 303, has a through hole 315 that pivotably connects to a pin on a deck 107. The length of the sealed electric actuator 109 is driven by an internal screw 401 which is coupled to a planetary gearbox 309 and an electric motor 307.

The internal screw 401 can be configured in many ways. An advantageous specification for the internal screw 401 has Acme double-lead thread at 4 threads per inch. At 4 threads per inch, weight supported by the sealed electric actuator 109 is not enough to overcome the friction between the threads of the screw and the nut plus the other frictional forces in the sealed electric actuator 109, to cause the screw to unwind under a full load, making this configuration self-locking. The same is true for vertical electric lifts 111. This self-locking feature of electric actuators is a very significant advantage over conventional hydraulic cylinders.

On a conventional car hauler with hydraulic cylinders, each hydraulic cylinder must have a parallel structure that allows the position of the cylinder to be pinned and carry the load so that load is not carried constantly by the hydraulic cylinder. Hydraulic cylinders are only to be used for changing the positions of decks. When a deck has reached the target position, each cylinder on both sides of the car hauler need to be pinned to take the load off the hydraulic cylinders. In contrast, the position of a sealed electric actuator 109 with internal screw 401 with an Acme double-lead thread at 4 threads per inch does not need to be pinned. The sealed electric actuator 109 will maintain its position under load due to the frictional forces in the sealed electric actuator 109 without any external force being applied. The same is true for the vertical electric lift 111. This feature of a car hauler fitted with sealed electric actuators 109 and/or vertical electric lifts 111 is significant time-saver during the loading and unloading process. The self-locking characteristic of the sealed electric actuators 109 and vertical electric lifts 111 eliminate the need for an operator to run around the car hauler setting and resetting pins to safely manipulate the decks.

Additionally, an electric actuator weighs less than an equivalent hydraulic cylinder configuration because the structural steel and other hardware needed to pin hydraulic cylinders is not needed. Adjustment of conventional hydraulic cylinders are limited to step changes governed by the periodic increments of the spacing between the pin holes. In contrast, electric actuators can be adjusted to any length within their stroke. In some cases, the continuous adjustability of electric actuators can make the difference in successfully making a load of vehicles (particularly those loads that include larger pickup trucks) that successfully stays within the height constraints for trucks on the highway.

A sealed electric actuator 109 rated for 5,000 lbs has an internal screw 401 that is 1 ½ inches in diameter. A sealed electric actuator 109 rated at 10,000 lbs has an internal screw 401 that is 1 ¾ inches in diameter. The internal screw 401 can be made of steel, stainless steel, or aluminum, most advantageously aluminum to minimize weight. Likewise, the planetary gearbox 309 can be configured in many ways. An advantageous specification is an 8 to 1 ratio where 8 rotations of the electric motor 307 generate one rotation of the internal screw 401. With these specifications, the sealed electric actuator 109 extends or retracts ½ inch with 8 rotations of the electric motor 307 which allows the sealed electric actuator 109 to actuate at similar speed to a traditional hydraulic actuator.

The internal screw 401 engages with a nut 403 on the lower end of the upper tube 303. The lower end of the upper tube 303 also has a pair of wear rings 405. The nut 403 has a retaining ring 407. The distal end of the internal screw 401 has an upper guide bushing 409 to keep the distal end of the internal screw 401 centered in the upper tube 303. The upper guide bushing 409 is affixed to the screw using a slotted nut 411 that is prevented from rotating by a roll pin 413. The end of the internal screw 401 proximate to the planetary gearbox 309 has a pair of tapered roller bearings 415 which are held on the internal screw 401 with a retaining nut 417. The pair of tapered roller bearings 415 engage with corresponding tapered roller bearing cups 419 which are housed in the bearing housing 311.

The lower tube 301 fits inside and is connected to the bearing housing 311 with set screws. The lower tube 301 has a plug 313 that allows access for the internal screw 401 to be lubricated with grease. The distal end of the lower tube 301 has a seal adapter 423 with internal wear ring 425, rod seal 427, and rod wiper ring 429. The bearing housing 311 is bolted to the planetary gearbox 309 with capscrews 431 with an interleaved gasket 433.

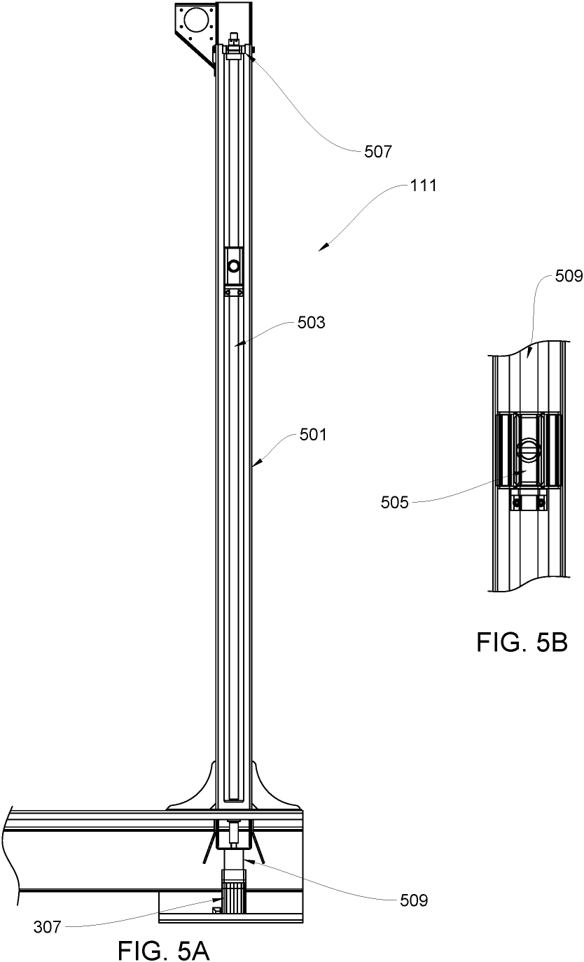

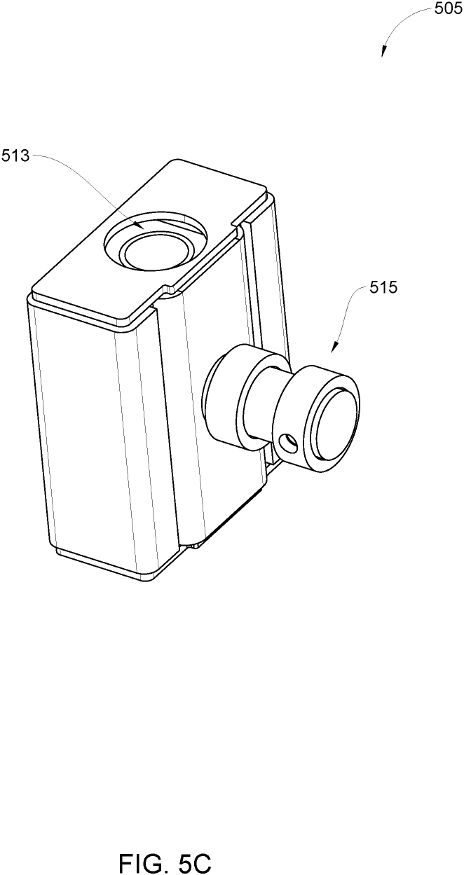

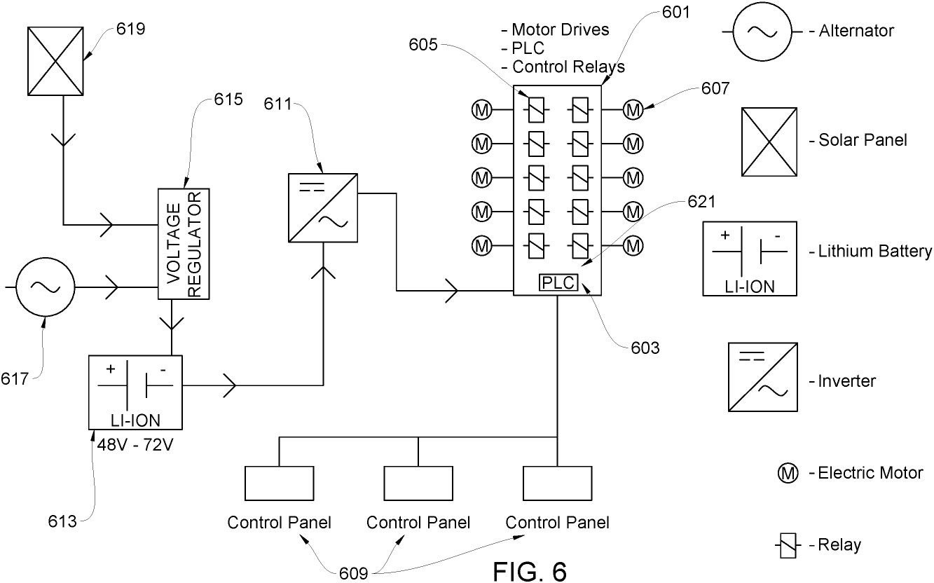

FIG. 5A shows a vertical electric lift 111. FIG. 5A shows an advantageous configuration with electric motor 307 located at the bottom of the screw, but the electric motor 307 can also be located at the top of the vertical electric lift 111 assembly. A steel column 501 houses the screw 503, screw slide assembly 505, and the top bearings 507. The screw slide assembly 505 slides up and down in the steel column with the rotation of the screw 503. Steel column 501 has a vertical slot 509 on the inside of the column for the screw slider pivot pin 515. The screw slider pivot pin 515 connects to a deck 107 and raises and lowers the deck with the rotation of the screw 503. The bottom of the screw 503 is restrained by bearings. The screw 503 hangs from the top bearings 507 to carry the weight of the load of the decks 107 and cargo. The screw 503 connects at the bottom to a planetary gearbox 509 which is then connected with the electric motor 307. The planetary gearbox 509 can be configured with multiple different gear ratios. It is advantageous for the planetary gear box 509 to be geared such that eight rotations of the electric motor 307 generate one rotation of the screw 503.

The screw 503 can be made of multiple different materials including stainless steel and aluminum. An advantageous specification for the internal screw 503 has Acme double-lead thread at 4 threads per inch. At 4 threads per inch, weight supported by the vertical electric lift 111 is not enough to overcome the friction between the threads of the screw and the nut plus the other frictional forces in the vertical electric lift 111, to cause the screw to unwind under a full load, making this configuration self-locking. This self-locking feature of electric actuators is a very significant advantage over conventional hydraulic cylinders.

The screw slide assembly 505 houses a nut 513 fitted to the screw 503. The nut 513 can be made of multiple different materials including bronze. The screw 503 and nut 513 can be lubricated with grease. Because the interior of the steel column 501 is exposed to the elements through the vertical slot 509, it is advantageous for the screw 503 and nut 513 to be self-lubricating and to not require grease. It is advantageous for the screw to made of aluminum and coated with dicronite and it is advantageous for the nut to be made of nyletron, impregnated with graphite. A double-lead screw at 4 threads per inch, made of aluminum coated with dicronite, coupled with a nyletron nut impregnated with graphite does not require grease for lubrication.

The electric motor 307 may be AC or DC. Each motor has an encoder to count the revolutions of the motor forward and backward. The output of the encoder is used by a programmable logic controller to determine the degree of extension of the electric actuator so that the system knows the position of each deck 107 at all times.

### Electrical and Control

The AC electric motors 607 are controlled from a centralized motor control station 601, one for the headrack and one for the trailer. Inside the centralized motor control station 601 is a programmable logic controller (PLC) 603 which is programmed to control motor drives 621 and the control relays 605, one control relay for each AC electric motors 607. The PLC 603 also receives feedback information from the encoder in each AC electric motors 607 so that it knows the position of each electric actuator. Control inputs to the PLC 603 are made from a control panel 609. The PLC 603 controls only a single pair of electric actuators (left and right) at a time so that both sides of the deck 107 are moving at the same time and the deck 107 is staying level from side to side. An operator manually actuates the switches in the control panel 609 to move the decks as required to load, unload, and configure the load for transportation.

The motor control station 601 receives AC power from an inverter 611 which converts DC power from the battery 613 to AC power. The inverter 611 outputs 240 V at 60 hertz with a 30-amp circuit breaker. The battery 613 is a lithium-ion battery with an output voltage of 48 or 72 volts with a capacity of 150 Amp Hours. The battery 613 provide DC power to the inverter 611 with a 250 amp circuit breaker. The battery 613 can be charged from the engine of the truck through an alternator 617 or from solar panels 619 through a voltage regulator 615. The battery 613 may also be charged by a cable plugged into an outlet on shore power.

On an open car carrier 101 the solar panels 115 may be located on the hood of the tractor. On an enclosed car carrier 201 the solar panels may be located on the roof of the headrack 203 and the trailer 205. The roof of an enclosed car carrier 201 can support more solar panel surface area than is available on the tractor of an open car carrier 101. The energy from the solar panels on an enclosed car carrier 201 are sized so that recharging of the battery will normally only be needed from the solar panels. The solar panels 115 on an open car carrier will be partially responsible for recharging the battery 613 and reduce the size of the battery needed to power the operation of the electric actuators.

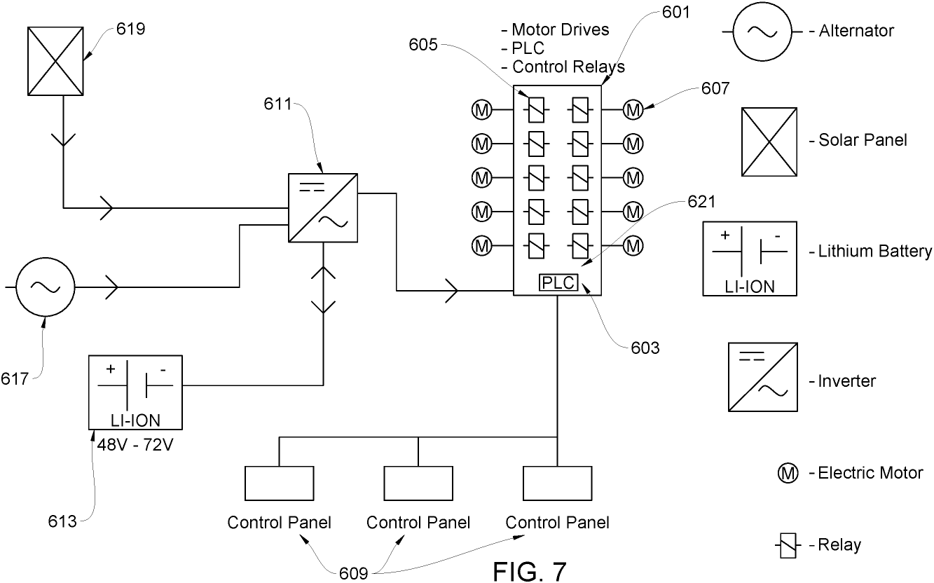

An alternative one-line wiring diagram for AC electric motors 607 is shown in FIG. 7. In this configuration, energy for recharging of the battery from the solar panels 619 and the alternator 617 is routed through the inverter 611, eliminating the need for a voltage regulator 615.

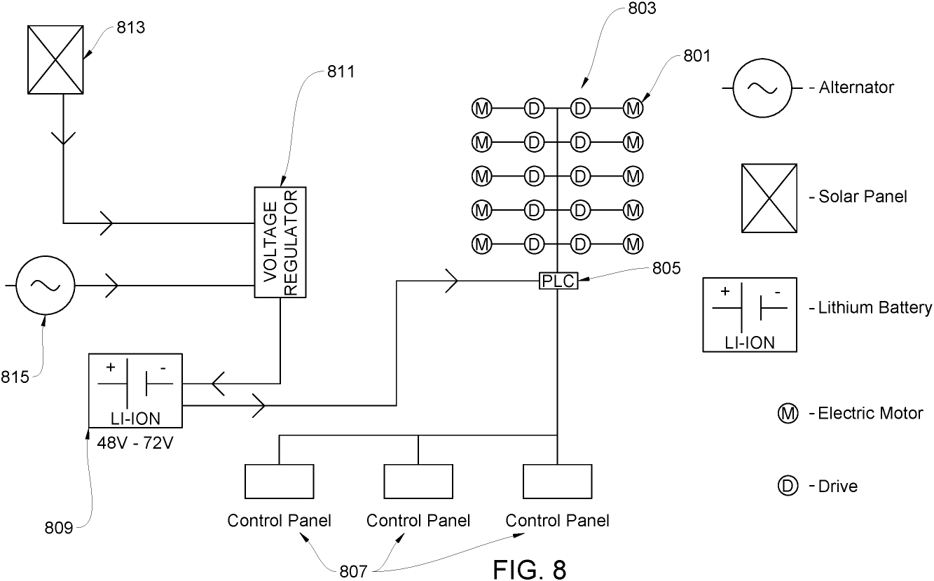

FIG. 8 shows the one-line wiring diagram for an alternative electric actuator design using DC electric motors 801. Each DC electric motor 801 requires one drive 803 in close proximity to each DC electric motor 801. The drives 803 are controlled by a PLC 805. Each DC electric motor 801 has an encoder which feeds back information about the number rotations the motor has made in each direction which allows the PCL 805 to know the position of each electric actuator. Power for the DC electric motors 801 is fed into the PCL 805 directly from the battery 809. The battery 809 is a lithium-ion battery with an output voltage of 48 or 72 volts with a capacity of 150 Amp Hours. The battery 809 can be charged from the engine of the truck through an alternator 815 or from solar panels 813 through a voltage regulator 811. The battery 809 may also be charged by a cable plugged into an outlet on shore power.

With either AC electric motors 607 or the DC electric motors 801, the electric actuator system has sufficient energy to complete the entire loading and unloading process a number times with the truck engine off. California law now restricts the ability of truck engines to idle. However, the law has an exception for situations for the state of the current technology does not permit truck operations to be performed without the engine running. Current car haulers are incapable of loading and unloading without the tractor engine running to power the hydraulic system. The car haulers herein will for the first time be capable of loading and unloading without needing the truck engine to run.

Both the AC PLC 603 and the DC PLC 807 execute functions to control the electric actuators. The AC PLC 603 has a local control panel to permit the operator to interface with the PLC.

In general, the AC PLC 603 function include the following functions: When the AC PLC 603 is powered up the PLC 603 cycles through and checks status of relays, checks that drives are ready, checks that sensors are ready, displays the results of these checks displayed on the screen.

When a deck is selected at the control panel 609, the AC PLC 603 closes the relays on left and right for the selected deck, verifies that the relay is closed for the correct deck, warns if any relays besides the selected deck are closed, prevents further action until problem is corrected, displays which deck besides the selected deck has relays that are closed, displays if deck is level (side to side) and if not then how much is it off, and times out and switches the selected deck to off if physical switches are not operated for 5 minutes after a deck has been selected.

When the control switch at the control panel 609 is activated to extend or retract a pair of electric actuators, the PLC 603 tells the drives to supply power to motors, receives and displays feedback from the drives as to the load on each motor, warns if the load from left to right is outside specified range, tells the drives to stop supplying power when the deck reaches top or bottom of its travel range, monitors whether the left and right side of the deck is staying level and increases or decreases speed of one side to compensate and bring to level, displays the location of the deck in inches from the bottom of travel range, disables the capability to select a different pair of electric actuators while drives are supplying power to the selected pair of electric actuators.

When the control switch at the control panel 609 is in the neutral position, the PLC 603 tells the drive to stop supplying power to motors of the selected deck, re-enables the function to pick the next deck.

When the operator is finished moving a selected deck he touches "off and the PLC 603 checks to make sure drive is not supplying power to motors, verifies that relay is open (disconnected) for the selected deck, and verifies that all relays are open and ready for the next deck selection.

The DC PLC 807 executes similar functions which are modified for the difference in configuration from the AC system.

What is claimed is:

1. A car hauler comprising:
a tractor with an engine and a trailer;
a plurality of movable decks to support vehicles;
a plurality of electric actuators connected to said movable decks;
said electric actuators are the only mechanism for relocating the position of the movable decks;
each said electric actuator has an electric motor, a screw, a nut, and a planetary gearbox;
said electric motors are powered by a battery; and
said battery has the capacity to power all the movements of the electric actuators necessary to completely load or unload the car hauler without the engine of said tractor running.

2. The car hauler of claim 1 further comprising:
said screw has a double-lead thread.

3. The car hauler of claim 1 further comprising:
said motor has an encoder.

4. The car hauler of claim 1 further comprising:
said motor is a DC electric motor.

5. The car hauler of claim 1 further comprising:
said motor is an AC electric motor.

6. The car hauler of claim 2 further comprising:
said double-lead thread has 4 threads per inch.

7. The car hauler of claim 1 further comprising:
each said electric actuator is self-locking.

8. The car hauler of claim 1 further comprising:
a plurality said electrical actuators are vertical electric lifts;
the nut of said vertical electric lift is made of nyletron impregnated with graphite; and
the screw of said vertical electric lift is made of aluminum and coated with dicronite.

9. The car hauler of claim 1 further comprising:
a plurality of said electric actuators are sealed electric actuators having telescoping tubes.

10. The car hauler of claim 1 further comprising:
a solar panel for recharging the battery.
